(19) United States
(12) Patent Application Publication
(10) Pub. No.: US 2015/0084446 A1
(43) Pub. Date: Mar. 26, 2015

(54) DIRECT DRIVE STACKED MOTOR ACUATOR

(71) Applicant: Electro-Motor Dynamics, LLC, Newtown, PA (US)

(72) Inventor: Siamak Atar, Newtown, PA (US)

(21) Appl. No.: 14/489,985

(22) Filed: Sep. 18, 2014

Related U.S. Application Data
(60) Provisional application No. 61/881,779, filed on Sep. 24, 2013.

(51) Int. Cl. H02K 16/00; H02K 1/04; H02K 11/00; H02K 1/27; H02K 3/26

(52) U.S. Cl. CPC H02K 16/00; H02K 1/2793; H02K 3/26; H02K 11/0021; H02K 1/04
USPC 310/43; 310/114; 310/68 B

(57) ABSTRACT

A motor actuator includes multiple rotors and stators arranged in an alternating configuration. Each rotor is located between two adjacent stators. Each rotor includes magnets assembled on a shaft. The stators are secured to a housing, and each stator has multiple coils embedded as traces within a printed circuit board (PCB). The motor actuator can function as a stepper motor, a continuous BLDC motor, a rotary absolute position encoder, an electricity generator, and a continuous torque meter in a single unit. A stacked configuration for the PCB motor results in a compact design, high torque output, low weight, and high efficiency.

### CROSS-REFERENCE TO RELATED APPLICATION

This application claims priority under 35 U.S.C. §119(e) from co-pending U.S. Provisional Application Ser. No. 61/881,779 filed Sep. 24, 2013, the entirety of which is hereby incorporated by reference herein.

### BACKGROUND

Motors have long been used for converting electrical energy into mechanical energy. Various operating principles for motors are known. Generally, motors use magnetic fields to produce force or torque. One type of motor is known as a pancake motor due to its relatively flat, circular shape. Pancake motors have historically been used in various applications such as floppy disk drives, medical devices, and industrial automation systems. High-level control of motors has generally been provided by external controllers. Hall effect sensors (Hall sensors), which provide an output voltage dependent on a magnetic field, are typically used for sensing rotor position within some types of motors, e.g., brushless direct current (BLDC) motors. Outputs from Hall sensors are typically used to control the operation of motors.

### SUMMARY

In some embodiments of the present disclosure, a motor actuator includes a plurality of rotors. Each rotor includes a plurality of magnets assembled on a shaft. A plurality of stators are secured to a housing. Each stator includes a plurality of coils embedded as traces within a printed circuit board (PCB). The rotors and stators are arranged in an alternating configuration with each rotor located between two adjacent stators.

In some embodiments, an apparatus includes at least one rotor, with each rotor including a plurality of magnets assembled on a shaft. At least one stator is secured to a housing. Each stator includes a plurality of coils. The plurality of coils of each stator includes sets of coils associated with respective phases of application of current to the coils. The coils in each set are electrically coupled in parallel to one another.

In some embodiments, a direct drive motor actuator includes at least one rotor, at least one stator, a positioning magnet, and a control circuit board. Each rotor includes a plurality of magnets assembled on a shaft. The stator(s) are secured to a housing, with each stator including a plurality of coils. The positioning magnet is located within the shaft. The control circuit board includes an absolute magnetic sensor configured to measure the angular orientation of the shaft based on a magnetic field of the positioning magnet. The control circuit board further includes a processor configured to process a signal received from the magnetic sensor and measures the angular speed of the shaft. The control circuit board also includes control circuitry configured to transmit the measured angular speed via a communications port.

### BRIEF DESCRIPTION OF THE DRAWINGS

The following will be apparent from elements of the figures, which are provided for illustrative purposes and are not necessarily to scale.

FIGS. 1A-1C are views of a motor actuator in accordance with some embodiments of the present disclosure. 1A: exploded view; 1B: perspective view; 1C: cross-sectional view.

FIG. 2 is a circuit diagram of a parallel phase coil configuration in a motor actuator in accordance with some embodiments.

FIG. 3 is a block diagram of a control board in accordance with some embodiments.

FIG. 4 is a profile view of a rotor assembled on a shaft in accordance with some embodiments.

FIG. 5 is a diagram illustrating interaction between rotor magnets and stator coils in accordance with some embodiments.

FIG. 6 is a diagram of a control board having an embedded coil in accordance with some embodiments.

### DETAILED DESCRIPTION

This description of certain exemplary embodiments is intended to be read in connection with the accompanying drawings, which are to be considered part of the entire written description. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. Likewise, terms concerning electrical coupling and the like, such as “coupled,” “connected” and “interconnected,” refer to a relationship wherein structures communicate with one another either directly or indirectly through intervening structures unless expressly described otherwise. Relative terms such as “lower,” “upper,” “horizontal,” “vertical,”, “above,” “below,” “up,” “down,” “top” and “bottom” as well as derivative thereof (e.g., “horizontally,” “vertically,” “downwardly,” “upwardly,” etc.) should be construed to refer to the orientation as then described or as shown in the drawing under discussion. These relative terms are for convenience of description and do not require that the apparatus be constructed or operated in a particular orientation.

In various embodiments of the present disclosure, a high torque motor actuator can be used as a direct drive mechanism or direct drive actuator. The motor actuator has a rotor shaft that serves as a holder for rotors. Multiple magnets are stacked on the shaft using spacers. Both sides of each magnet are used to interact with surface coils embedded within a printed circuit board (PCB) stators as traces. By using both sides of the magnets, an increase in torque is created compared to using one side alone. A stacked configuration for the PCB motor results in a compact design, high torque output, low weight, and high efficiency. Motor actuators in various embodiments do not require Hall sensors and instead use non-contact absolute magnetic encoders to develop the rotor orientation angle, from which the commutation electrical angle is calculated. Thus, software is used to generate simulated or equivalent commutation electrical angles based on rotor orientation angle in place of Hall sensors. The use of contactless control sensors and contactless commutation yields increased life expectancy relative to traditional motors. Motor actuators in accordance with various embodiments of the present disclosure are a replacement for stepper motors, DC motors, legacy brushless DC (BLDC) electric motors, and direct drive actuators.

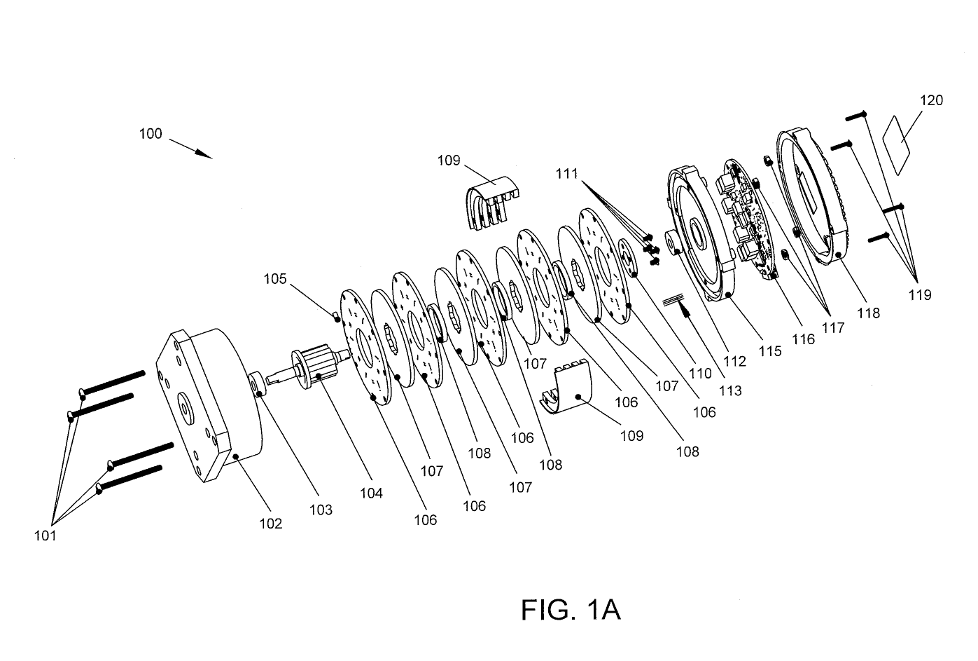

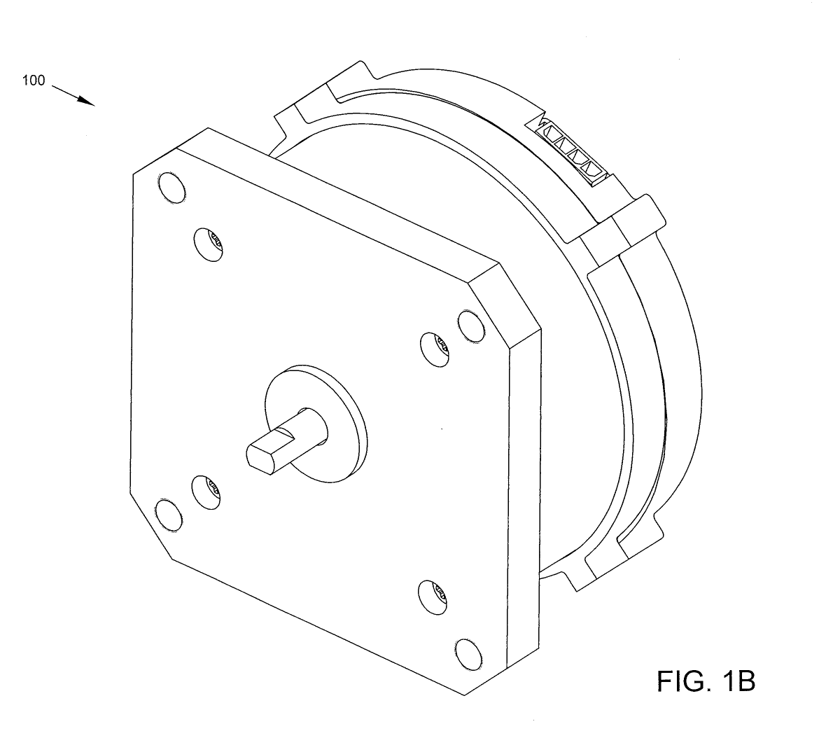

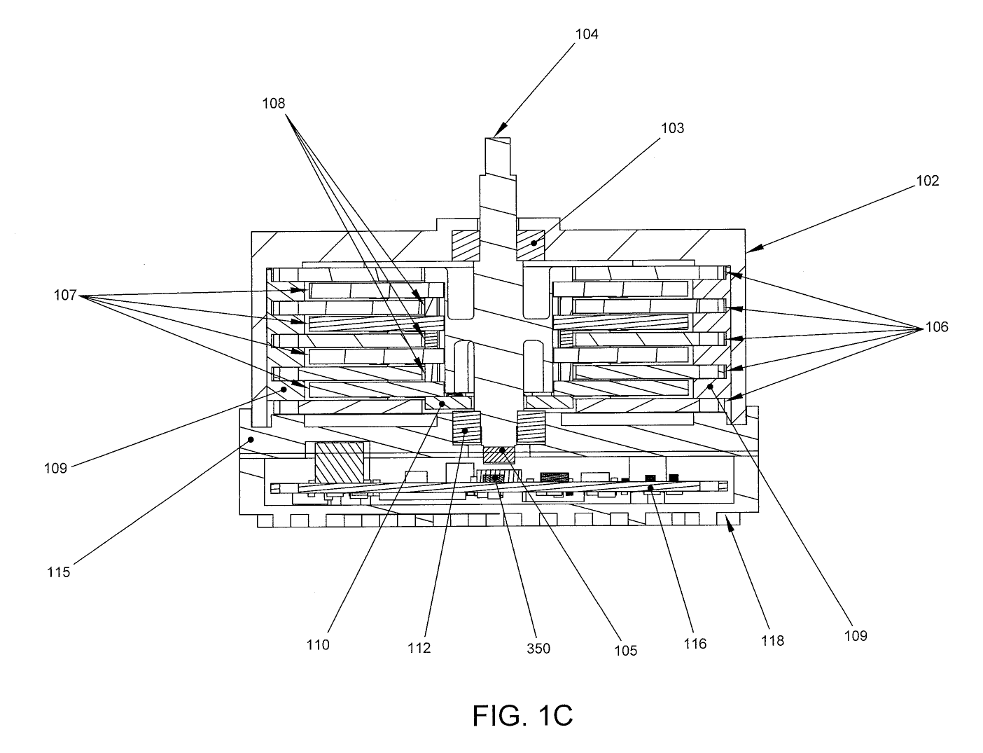

A motor actuator 100 in accordance with various embodiments is shown in exploded view in FIG. 1A, in perspective view in FIG. 1B, and in cross-sectional view in FIG. 1C. Referring to FIG. 1A, in some embodiments, motor actuator 100 includes multiple flat, circular rotors 107 that each contain multiple permanent magnets (e.g., multi-pole flat magnets) assembled on a main rotor shaft 104. The rotor shaft 104 is used to secure the magnets of rotors 107 and to center-align them within a motor housing 102. The motor housing 102 may be made of industrial plastic such as polytherimide, which reduces weight compared to traditional motor housings made of aluminum. Material may be removed from the interior of the rotor shaft 104 in such a way as to reduce weight and to maintain strength. In this design, the multi-pole flat magnets of rotors 107 experience a radial load, so these magnets may be tightened and secured at the end using a small cap 110 and affixed using screws 111. This design keeps the magnets secured and aligned with minimal force.

For ease of understanding, Table 1 below lists various parts appearing in FIG. 1A.

TABLE 1
Listing of parts in FIG. 1A

| Reference numeral | Part |
|---|---|
| 101 | screw |
| 102 | motor housing |
| 103 | front ball bearing |
| 104 | rotor shaft |
| 105 | positioning magnet |
| 106 | stator |
| 107 | rotor |
| 108 | rotor spacer |
| 109 | stator separators |
| 110 | cap |
| 111 | screw |
| 112 | back ball bearing |
| 113 | wires |
| 114 | O-ring |
| 115 | back flange |
| 116 | control board |
| 117 | nut |
| 118 | back/bottom shell |
| 119 | screw |
| 120 | back plate |

The rotor magnets of rotors 107 may be formed from suitable high-magnetic materials such as neodymium. The motor actuator 100 also includes multiple flat, circular stators 106 with windings that form at least one pole. The number of poles within each stator disk 106 may vary, e.g., 6, 8, or another number of poles. In some embodiments, the number of poles in each rotor 107 is more than the number of poles in each stator 106. The stator windings may include multiple circuit traces using Printed Circuit Board (PCB) technology. Any other winding type that can be extruded within high temperature plastic materials may be used as well. The use of PCB technology allows the stator windings to reliably sustain high voltages up to the limits of the PCB dielectric coefficient, while maintaining a compact profile. The typical thickness of a stator using this fabrication technology may range from 0.04 inches to 0.118 inches thick. The use of coil printed circuit boards (PCBs) utilizing multilayer PCB technology allows higher turns of windings compared to using physically-wound wire coils.

The use of PWB technology also provides a durable configuration, which has several advantages. Such a PCB coil configuration eliminates wear or breakage of the coils, because movement is restricted. This configuration permanently fixes the distance between traces, which allows for stable motor performance. Also, this configuration allows the stator assembly to operate in higher temperature environments compared to traditional wire-based coil technology. The thickness of the stator PWB traces may be tailored to establish the intended performance of the motor, with thicker traces increasing the current-carrying ability of coils and thereby improving torque performance, and thinner traces increasing the voltage-carrying ability of coils and thereby increasing motor speed.

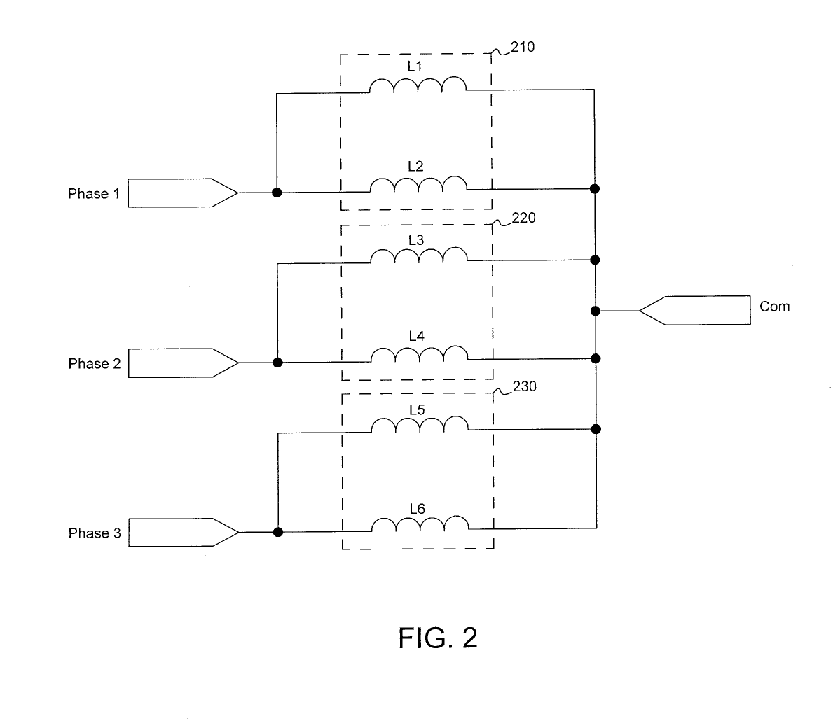

The coils of each stator 106 may include sets of coils associated with respective phases of application of current to the coils. The coils in each set may be electrically coupled in parallel to one another, or a serial coupling configuration may be used instead. For example, FIG. 2 shows a three-phase motor configuration with parallel phase coils. Coils L1 and L2 in a first set 210 are associated with a first phase of current application, coils L3 and L4 in a second set 220 are associated with a second phase, and coils L5 and L6 in a third set 230 are associated with a third phase. The use of parallel phase coils, yields higher torque at a given voltage and increases the reliability of the motor in a harsh environment. For example, if the interconnection between coils L1 and L2 gets disconnected the motor will still continue to work, unlike a motor with a serial phase coil configuration. Reliability may be further improved by stacking rotors and stators in a multilayer configuration as shown in FIG. 1A and described further below. For example, with a five layer stacking as in FIG. 1A, reliability increases by an additional factor of reliability when compared with single-layer serial phase coil motors. Another benefit from the parallel phase coil configuration is decreased counter-electromotive force (CEMF or back EMF). The reduction in CEMF is due to the reduction in coil inductance that results from the parallel coil configuration.

The PCB design of the stator windings may incorporate the use of various winding types that can be extruded, such as high temperature plastic extrusion materials. The use of PCB technology allows the motor actuator 100 to operate in a so-called “coreless configuration” (i.e. without any permeable core materials within the stators) in some embodiments. The coreless configuration significantly reduces the weight and the cost of the motor actuator 100 and allows for operation at high switching frequencies (e.g., 1 MHz and higher) compared with conventional ferrous-core stators that typically switch at 15 kHz or lower. The use of higher switching frequencies enhances the current-carrying capability of the stator coils as a result of the surface effect associated with current-carrying conductors. The surface effect refers to the phenomenon that high frequency currents flow mainly on the surface of conductors. The net effect is a reduction in the resistance of the stator coil conductors. Reduced resistance within the stator coils reduces coil self-heating effects, reduces heat dissipation, reduces thermal demand on the assembly heat sinks, improves reliability, and reduces weight and cost of the motor actuator. Also, in some embodiments the lack of ferromagnetic metal core eliminates efficiency losses arising from electromagnetic field saturation in iron.

Referring back to FIG. 1A, each rotor 107 is axially displaced from two adjacent stators 106 by a small amount. The configuration of multiple stators 106 and multiple rotors 107 forms a stacked configuration resulting in simple and compact construction. The arrangement of alternating stators and rotors in multiple layers may also be referred to as a multi-stacked configuration. The specific configuration of stators and rotors, including the thickness of the stators/rotors, the diameter of stators/rotors, and the quantity of stators/rotors, can be varied and can be used to control the motor's performance characteristics, including power, speed, torque and efficiency. The multi-stacked configuration enables magnetic fields to be generated at both sides of each stator 106.

In some embodiments, the stators 106 are affixed to the motor housing 102 and the rotors 107 are affixed to the rotatable rotor shaft 104. The combination of rotors 107 and the rotor shaft 104 is referred to herein as the rotor assembly. Each rotor 107 interacts with the magnetic fields created by two adjacent stators 106. This interaction results in improved motor performance and efficiency.

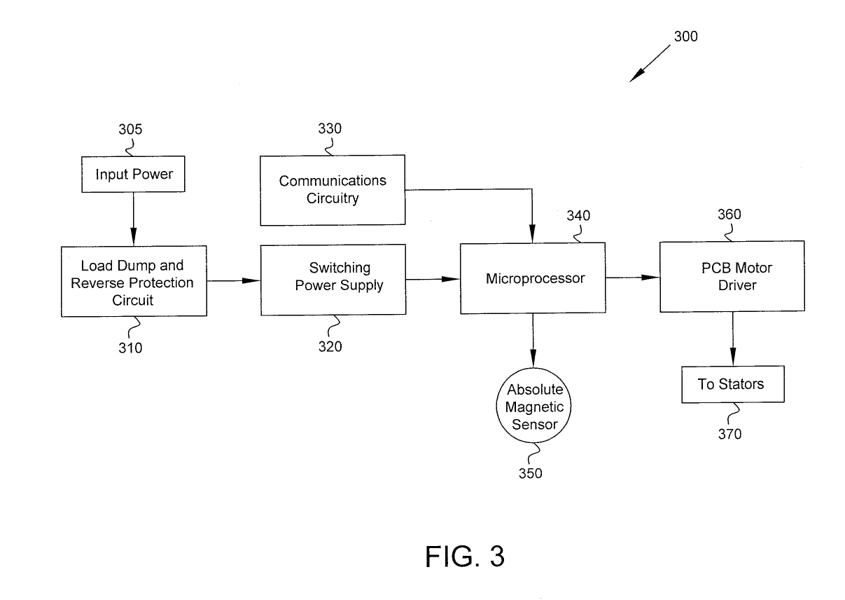

A control board 116 regulates input power to the motor, provides an electronic control interface for the motor, houses an absolute magnetic sensor 350 (FIG. 3) used to determine the angular position of the rotors 107 relative to the fixed stators 106, and provides power to the stator coils, which creates the magnetic fields that interact with the rotor magnetic fields. Screws 101 and nuts 117 (FIG. 1A) may be used to secure the motor housing 102, stators 106, and control board 116. The absolute magnetic sensor 350 may be centrally installed on the control board 116 so that it is located in close proximity to the rotating positioning magnet 105, which may be press fit into the rotor shaft 104. This configuration enables the motor actuator 100 to operate as a direct drive actuator. The absolute magnetic sensor 350 may be configured to operate as a 360 degree sensor, 180 degree sensor, 90 degree sensor, or may be configured for any other angular orientation of operation to support other specific application requirements. The use of direct sensor attachment to the rotor shaft 104 makes this actuator appropriate for use in micro-step closed loop control applications. In this configuration, the motor actuator 100 can be used to replace conventional stepper motors. The use of an absolute magnetic sensor for feedback enhances performance of motor actuator 100 in high vibration environments.

An electronics communication port may be provided on the control board 116 to allow external control, via signal(s) 330, over operating parameters of the motor actuator 100, in a mode referred to as “drive-by-wire.” The use of an absolute encoder on the back side of the rotor shaft 104 provides an additional capability for the motor actuator 100 to work as an absolute rotary encoder when the motor is in idle mode. This device 100 can function as a stepper motor, a continuous BLDC motor, a rotary absolute position encoder, an electricity generator, and a continuous torque meter in a single unit.

Regulated DC input power 305 may be furnished externally to the motor actuator 100. Front-end protection circuitry 310 is provided to prevent damage to the motor as a result of inadvertent input power reversal. Front-end protection circuitry is also provided to prevent damage to the motor as a result of load dump, i.e., an input power surge condition frequently encountered in automotive applications. Front-end input voltage regulation circuitry allows the motor actuator to operate with a wide range of input voltage. The motor actuator in this embodiment may operate from +6V to +60V, whereas typical BLDC motors operate from +8V to +24V.

The use of an integrated microprocessor-based controller 300 within the motor actuator results in an improvement in control. For example, conventional motors rely on an external controller. However, the use of an integrated controller provides several advantages including reduction in the number of interconnecting wires thereby reducing assembly and material costs, improvement in response time due to the elimination of control signal propagation delays through the wires, and increased reliability due to the elimination of connector contacts.

The regulated DC input power may be converted to trapezoidal pulse width modulation (PWM) DC power or vector based PWM before being distributed to various internal circuits. Conditioned DC power is derived from the regulated DC input power through the use of a switching power supply 320, which makes the motor appropriate for operation in higher temperatures without heat generation from the controller. Conditioned DC power is distributed to internal circuits including a microprocessor 340 located on the control board 116, the absolute magnetic sensor circuitry 350, the communication circuitry 330, and a PCB motor driver 360.

The microprocessor 340 controls the operation of the motor actuator 100. The microprocessor 340 may incorporate digital signal processing (DSP) capability, and the use of high speed floating point calculations increases accuracy of feedback to the stators 106. The microprocessor 340 receives and conditions the signal(s) from the absolute magnetic sensor 350 and uses this information to develop the appropriate drive signals to the coils of the stators 106. The microprocessor 340 interfaces with the electronics communication port 330, which may accommodate various types of input signals including controller area network (CAN), PWM, RS232, Ethernet, Ethernet for Control Automation Technology (Ethercat), USB and others.

The microprocessor 340 also monitors conditions such as internal temperature and input voltage of the motor actuator 100. Conditions beyond maximum allowable parameters are detected, allowing the microprocessor 340 to protect the motor actuator 100 when, e.g., high input voltage, high ambient temperatures or heavy operating loads result in hazardous operating conditions.

The PCB motor driver 360 develops and controls the stator coil energy in terms of amplitude, waveform and frequency in order to realize a variety of classical motor motions including fixed-rotation-rate rotary motion, variable-rotation-rate rotary motion, stepper (start/stop) motion and forced position-hold motion. In some embodiments, the controller is capable of driving the coils in two modes that may be toggled by a software setting: trapezoidal and vector control. In trapezoidal mode, only two of the three phases' coils are energized at a time, these being the coil sets directly across from each other, and the motor creates ⅔ of the main torque. In vector mode, all three phases are involved; this is also known as “field-oriented control.” In order to utilize vector control, the motor must have absolute position feedback. The control board 116 and the absolute magnetic sensor 350 provide application flexibility since they support trapezoidal control waveforms or 3-phase, vector control within the motor.

The output of the PCB motor driver is conveyed back to the stators (370, FIG. 3) via wires (113, FIG. 1A). In traditional 3-phase motor systems, there are at least eight wires between a motor and a control board for conveying the three phases of stator currents, the outputs from three Hall sensors, and two power lines (e.g., ground and power). In some embodiments of the present disclosure, there are exactly four wires (two wires for power/ground, two wires for network communication port) between the motor and the control board that convey the three phases of the stator currents. The angle of the rotors is calculated by the use of non-contact absolution position sensors instead of three independent Hall sensors, and thus separate wires are not needed for respective Hall sensors.

The motor actuator is able to achieve a variety of motion, including rotational drive energy, rotational braking energy, linear drive energy, linear braking energy and linear hold energy. In some embodiments, the motor actuator 100 can also be configured as a generator that converts rotating mechanical energy applied to the rotor shaft 104 into electrical energy at the output of the stator coil assemblies. Traditional geared actuators are not able to convert rotating mechanical energy applied to a shaft into electrical energy due to the use of gears that create a mechanical restriction. In contrast, the gearless configuration of embodiments of the present disclosure enables the motor actuator 100 to function as a generator.

Referring back to FIG. 1A, rotors 107 are attached to the rotor shaft 104. Individual pairs of rotors 107 are separated by rotor spacers 108, which are used to secure and radially align the rotors 107 and to maintain the axial alignment of the rotors 107. The stator separators 109 are firmly secured to the motor housing 102, resulting in a unified stator assembly. Due to the stacked arrangement of the stators, no soldering is required for these components. The stator separators 109 may be fabricated as a single part using an extrusion process. Conventional motors use individual machined parts that are separately assembled, which results in an accumulation of stack up tolerances. The use of extrusion processes achieves tolerances that are better than fabricated machined part tolerances, and eliminates accumulating stack up tolerances between stators 106.

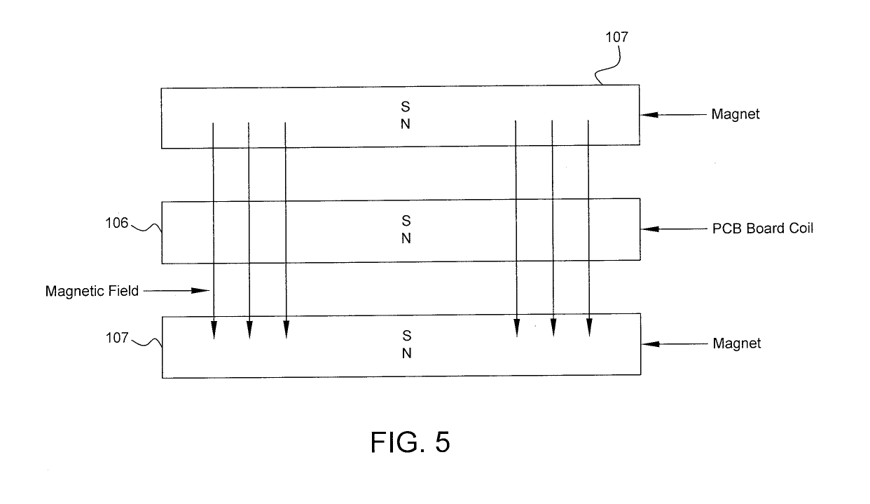

Rotor spacers 108 are used to maintain axial spacing between each rotor 107. The rotor spacers 108 and rotors 107 may be fabricated using high-strength, low-weight materials (e.g., non-iron-based material(s)) to reduce rotational inertia. The rotor spacers 108 do not need to be fabricated using iron or other ferrous materials. The strong magnetic attraction between poles of each rotor disk 107 serves to self-align the magnetic poles during the manufacturing assembly process (see discussion below regarding FIG. 5).

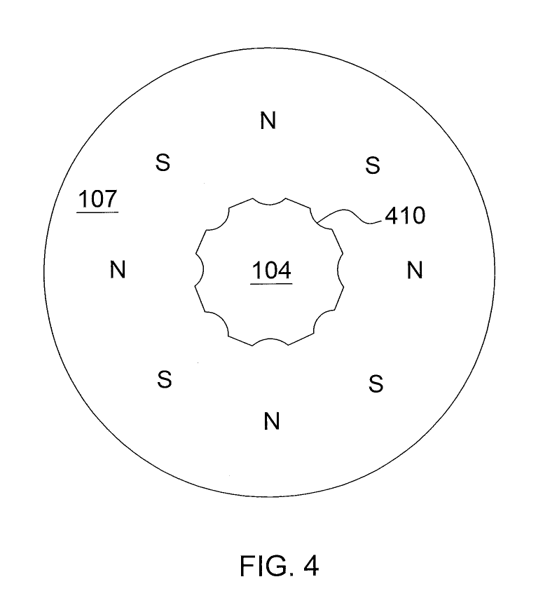

As shown in FIG. 4, a unique curvature profile is fabricated into the rotor shaft 104, which corresponds with a complementary profile fabricated into each rotor 107. The north and south magnetic poles are shown arranged radially for rotor 107. Grooves 410 are used to maintain radial alignment of the rotors' magnetic fields and to provide a torque transfer surface between each rotor 107 and the rotor shaft 104. The curvature profile as shown in FIG. 4 distributes uniform torque to each multi-pole flat magnet. The grooves 410 are designed to maximize torque transfer and to minimize stress concentration within the rotor material that could otherwise lead to material fatigue and failure within the rotor 107.

Referring back to FIG. 1A, a cap 110 is attached to the rotor shaft 104 to axially secure the rotors 107 and rotor spacers 108 onto the rotor shaft 104. This design keeps the magnets of the rotors 107 secured and aligned with minimal force. Material may be removed from the interior of the rotor shaft 104 to reduce weight and to maintain strength.

The rotor shaft 104 may be fabricated from non-ferrous, lightweight material(s) such as plastic, e.g., polytherimide. Conventional motors use ferrous materials in the fabrication of the rotor shaft 104. Ferrous materials are very heavy, which is a shortcoming of iron-based rotor shafts. In various embodiments of the present disclosure, the use of lightweight rotor shaft materials reduces the inertia of the rotor shaft 104, thereby improving motor spin-up and control performance.

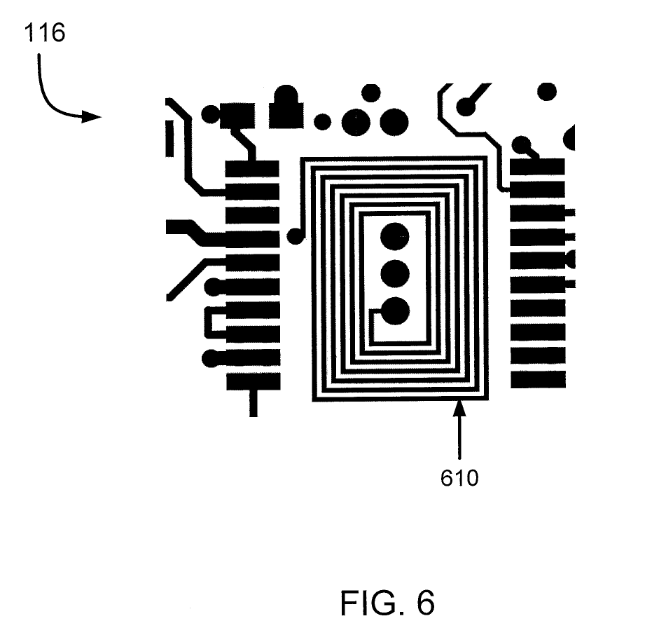

The rotor shaft 104 may be built using lightweight materials such as aluminum or brass. A positioning magnet 105 may be inserted inside the rotor shaft 104 with no risk of field loss, thus eliminating a shortcoming of iron-based shafts. For example, the positioning magnet 105 may be press-fit into the rotor shaft 104, eliminating the need for a plastic insertion part that is traditionally used for the positioning magnet holder. The positioning magnet 105 works with the absolute magnetic sensor 350 on the control board 116 to provide a sensed indication of the angular position of the rotor assembly. This sensed indication is the source of a speed measurement realized by an embedded coil circuit 610 on the center of the control board 116 as shown in FIG. 6 or through the use of an angular feedback chip.

In some embodiments, the ends of the rotor shaft 104 are press-fit into a front ball bearing 103 and a back ball bearing 112. These ball bearings are press-fit into a flange of a motor housing 102 and a back flange 115, respectively. The flange of the motor housing 102 acts as a holder for the front ball bearing 103 and axially aligns the rotor shaft 104. An annular ring on the inside edge of back flange 115 fits inside the motor housing 102 and provides a mechanism of self-alignment between the back flange 115 and the motor housing 102. The use of press-fit ball bearings automatically center-aligns the rotor shaft 104 within the motor housing 102, thereby eliminating costly alignment operations during motor assembly. The ball bearings 103, 112 may be fabricated using ferrous (e.g., stainless steel) materials. The use of a ferrous back ball bearing 112 shields the positioning magnet 105 from external magnetic fields created by the rotors 107 and stators 106. Bali bearings 103, 112 may each be replaced by a roller bearing, graphite bushing or other suitable bearing device. A back/bottom shell 118 may be fabricated from extruded plastic materials and is used to cover the control board 116. Because the motor housing 102 and back flange 115 form a sealed assembly, the ball bearings 103, 112 do not have to be sealed.

O-rings 114 are used at the joint between a top flange of motor housing 102, the back flange 115, and the back/bottom shell 118. The use of O-rings results in a completely sealed BLDC motor housing. The use of a sealed motor housing keeps water and debris out of the assembly, and eliminates the need to utilize sealed ball bearings, thereby reducing costs associated with the ball bearings.

The entire BLDC motor assembly is unitized with axial hardware, e.g., screws 101 and nuts 117 that run through the motor housing 102, stator separators 109, stators 106, back flange 115, and back/bottom shell 118. The back/bottom shell 118 may be attached to the back flange 115 using screws 119. This configuration also provides an effective heat sink mechanism. The motor housing 102, back/bottom shell 118, and flanges (e.g., back flange 115 and a front/top flange in the motor housing 102) are fabricated with materials that exhibit high thermal conductivity (e.g., laminated iron or composites) in order to dissipate heat developed by the motor. The use of high thermal conductivity materials has not normally been used in the past for motors.

The control board 116 is an electronic circuit board that is attached to a flange on the back/bottom shell 118. The flange on the back/bottom shell 118 also serves as a heat sink to dissipate heat generated by the control board 116. Inside the center of the control board 116, a rotary coil 610 which may be embedded in multiple layers (e.g., six layers) acts as a tachometer to measure speed. The speed measurement may be performed using the rotary coil 610 in the control board 116 as shown in FIG. 6. The back/bottom shell 118 covers the control board 116. The back/bottom shell 118 may be fabricated from extruded plastic materials. The back/bottom shell 118 can also act as a heat sink for the control board 116. The control board 116 has an interface connector that is accessible through a cutout provided in the back/bottom shell 118. This connector is used for power and control purposes.

FIG. 5 shows the magnetic field interaction between the rotors 107, including permanent magnets, and the stators 106, including energized coil windings. In some embodiments, the rotors 107 utilize an 8-pole permanent magnet configuration (see FIG. 4) and the stators use a 3-phase/6-coil configuration (see FIG. 2), but other configurations are possible. The control board 116 maintains the amplitude and phase of the stator magnetic fields by controlling the current delivered to these coils, the relative phase of these current signals, and the wave shapes of the current delivered to these coils. At the same time, the control board 116 senses the angular position of the rotors 107 through the use of the absolute magnetic sensor 350. This combination of the control board 116 and the absolute magnetic sensor 350 provides closed-loop, vector-based control of the motor's operation. The closed-loop design also ensures that the voltage and current delivered to the stator coils are maintained within a safe operating range to prevent motor overheating. The control board 116 also ensures that mo or stall current is maintained within a safe operating range to prevent motor burn-out.

Although examples are illustrated and described herein, embodiments are nevertheless not limited to the details shown, since various modifications and structural changes may be made therein by those of ordinary skill within the scope and range of equivalents of the claims.

What is claimed is:

1. A motor actuator comprising:
a plurality of rotors, each rotor in said plurality of rotors including a plurality of magnets assembled on a shaft;
a plurality of stators secured to a housing, each stator in said plurality of stators including a plurality of coils embedded as traces within a printed circuit board (PCB);
wherein the rotors and stators are arranged in an alternating configuration with each rotor located between two adjacent stators.

2. The motor actuator of claim 1, further comprising:
a positioning magnet located within the shaft; and
a control circuit board including a magnetic sensor configured to measure an angular orientation of the shaft based on a magnetic field of the positioning magnet.

3. The motor actuator of claim 2, wherein the controller is configured to control power supplied to the coils of the stators in response to the measured angular orientation of the shaft.

4. The motor actuator of claim 2, wherein the positioning magnet is press fitted to the shaft.

5. The motor actuator of claim 1, further comprising a plurality of non-ferrous magnet spacers arranged around the shaft, each magnet spacer abutting one of the rotors.

6. The motor actuator of claim 1, wherein the shaft is a non-ferrous shaft.

7. The motor actuator of claim 6, wherein the shaft is a thermosetting plastic shaft.

8. The motor actuator of claim 1, further comprising:
a flange configured to align the magnets to the shaft and to the housing; and
a control board attached to the flange, the control board including a microprocessor.

9. The motor actuator of claim 8, wherein the flange includes laminated iron.

10. The motor actuator of claim 8, wherein the flange includes polytherimide.

11. The motor actuator of claim 1, further including a flange, a first ball bearing press fitted into the housing, and a second ball bearing press fitted into the flange;
wherein the flange includes an annular ring configured to fit inside the housing.

12. The motor actuator of claim 1, further including a tachometer configured to measure the angular speed of the shaft.

13. The motor actuator of claim 1, wherein the motor actuator is a direct drive actuator.

14. The motor actuator of claim 1, wherein the plurality of coils of each stator includes sets of coils associated with respective phases of application of current to the coils, wherein the coils in each set are electrically coupled in parallel to one another.

15. The motor actuator of claim 1, wherein the motor actuator is gearless and operable to convert rotating mechanical energy applied to the shaft into electrical energy at an output of the stators.

16. An apparatus comprising:
at least one rotor, each rotor including a plurality of magnets assembled on a shaft;
at least one stator secured to a housing, each stator including a plurality of coils, wherein the plurality of coils of each stator includes sets of coils associated with respective phases of application of current to the coils, wherein the coils in each set are electrically coupled in parallel to one another.

17. The apparatus of claim 16, wherein the at least one rotor includes N rotors, wherein N is a positive integer;
wherein the at least one stators includes N+1 stators; and
wherein the rotors and stators are arranged in an alternating configuration with each rotor located between two adjacent stators.

18. The apparatus of claim 16, wherein each rotor is circular and defines a circular central opening, each stator is circular and defines a circular central opening, and the shaft extends through the central openings defined by the stators and the rotors.

19. A direct drive motor actuator comprising:
at least one rotor, each rotor including a plurality of magnets assembled on a shaft;
at least one stator secured to a housing, each stator including a plurality of coils;
a positioning magnet located within the shaft; and
a control circuit board including:
a magnetic sensor configured to measure an angular orientation of the shaft based on a magnetic field of the positioning magnet,
a processor configured to process a signal received from the magnetic sensor and measure an angular speed of the shaft, and
control circuitry configured to transmit the measured angular speed via a communications port.

20. The direct drive motor actuator of claim 19, further including exactly four wires coupled to the control circuit board.

21. The direct drive motor actuator of claim 20, wherein one of the wires is coupled to a power source, another of the wires is coupled to an electrical ground, and the communications port includes the other two wires.
